(19) United States
(12) Patent Application Publication
(10) Pub. No.: US 2008/0043013 A1
(43) Pub. Date: Feb. 21, 2008

(54) System for designing shopping environments

(75) Inventors: Matthew K. Gruttadauria, Yarmouthport, MA (US); Gregory A. Pelegrin, Menasha, WI (US); Michael J. Nelson, Neenah, WI (US); Mark Edwards, Buckinghamshire (GB)

Correspondence Address: KIMBERLY-CLARK WORLDWIDE, INC.;Catherine E. Wolf, 401 NORTH LAKE STREET, NEENAH, WI, 54956, US

(73) Assignee: Kimberly-Clark Worldwide, Inc, Neenah, WI (US)

(21) Appl. No.: 11/639,783

(22) Filed: Dec. 15, 2006

Related U.S. Application Data
(60) Provisional application No. 60/815,075, filed on Jun. 19, 2006.

(51) Int. Cl. G06T 15/00

(52) U.S. Cl. 345/419

(57) ABSTRACT

A shopping environment design system comprises a computing environment; a virtual reality system operatively associated with the computing environment and configured to produce a virtual reality shopping environment according to at least one three-dimensional image of the virtual reality shopping environment, the three-dimensional image including design elements selected from one or more of store layout, aisle configuration, aisle appearance, shelf layout, product displays and product placement on shelves; a design element modifying tool configured to modify the design elements, whereby the virtual reality shopping environment is changed; and a consumer response measurement tool configured to measure responses of a user interacting with the virtual reality shopping environment. In some aspects, the shopping environment includes a theme area and an activity-based product grouping.

The present application claims the benefit of the prior, co-pending U.S. Provisional Patent Application Ser. No. 60/815,075 entitled SYSTEM FOR DESIGNING SHOPPING ENVIRONMENTS by M. Gruttadauria et al., which was filed Jun. 19, 2006 (attorney docket No. 64103282US01), the entire disclosure of which is incorporated herein by reference in a manner that is consistent herewith.

### BACKGROUND

The manufacture, marketing, and sales of consumer products is highly competitive, and product manufacturers spend enormous sums of money designing and testing store layouts and other retail environments, aisle layouts, products and product packaging. To assist with this important topic, virtual reality tools have been developed to provide concept visualizations. For example, the advent of sophisticated virtual reality software and other related tools has enabled several new advances in consumer product marketing and market research.

Virtual shopping simulations typically involve placing an individual, or participant, in front of a computer monitor and presenting the participant with a visual simulation of a store aisle or other portions of a retail shopping environment. The individual may then be allowed to perform various predefined actions. For example, the individual may be prompted to select a product for purchase from an array of similar products, or the user may be allowed to navigate from one location of the virtual store to another using a mouse pointer and a keyboard. In some cases, the participant may merely be exposed to a new merchandising concept developed in virtual reality without interaction. As the user makes product purchasing decisions, the selections can be recorded. The results of such simulations may be used by designers to make changes in the design and/or packaging appearance of a given product.

While it is known to use virtual reality software tools to simulate shopping for consumer research, there remains a need for improved techniques for simulating and developing shopping environments using virtual reality systems. There is also a need for an integrated system of virtual reality tools that can bring manufacturers and retailers together to jointly explore in a data-rich virtual environment the consumer/market impact of proposed designs for product placement, shelf layout, store aisles layout, and overall store layout, as well as other aspects of selling products in retail environments. There is a further need for a system which provides a shopping environment which can be designed around an activity-based theme.

### SUMMARY

In response to the needs discussed above, the present invention relates to a system for designing shopping environments, including a virtual reality environment, where a manufacturer and a retailer jointly work with a three-dimensional image of the retailer's store and modify aspects of the three-dimensional image in order to explore and optimize design options and to research the impact of such design options on consumer behavior and resulting sales.

In one particular aspect of the invention, a shopping environment design system comprises a computing environment; a virtual reality system operatively associated with the computing environment and configured to produce a virtual reality shopping environment according to at least one three-dimensional image of the virtual reality shopping environment, the three-dimensional image including design elements selected from one or more of store layout, aisle configuration, aisle appearance, shelf layout, product displays and product placement on shelves; a design element modifying tool configured to modify the design elements, whereby the virtual reality shopping environment is changed; and a consumer response measurement tool configured to measure responses of a user interacting with the virtual reality shopping environment. In some aspects, the three-dimensional image is presented using virtual reality. In other aspects, the three-dimensional image is a current layout of a retail store. In yet other aspects, the three-dimensional image is an alternative layout of a retail store. In still other aspects, the shopping environment design system further includes multiple virtual representations of a shopping environment. In some aspects, a simulation participant interacts within an immersive virtual environment. In other aspects, the shopping environment design system further comprises multi-sensory aspects. In still other aspects, the simulation participant is recorded during a simulation. In yet other aspects, the shopping environment design system further includes real consumer data. In still other aspects, the shopping environment is linked to live data from multiple shoppers. In some aspects, the shopping environment is designed jointly by a retailer and a manufacturer. In other aspects, changes to the shopping environment are proposed by a simulation participant. In yet other aspects, the shopping environment is displayed over a network. In still other aspects, changes to the shopping environment are made real-time.

In another particular aspect of the invention, a shopping environment design system comprises a computing environment; a virtual reality system operatively associated with the computing environment and configured to produce a virtual reality shopping environment according to at least one three-dimensional image of a shopping environment, the three-dimensional image including design elements selected from one or more of store layout, aisle configuration, aisle appearance, shelf layout, product displays and product placement on shelves; where the shopping environment includes a theme area and an activity-based product grouping; a design element modifying tool configured to modify the design elements, whereby the virtual reality shopping environment is changed; and a consumer response measurement tool configured to measure responses of a user interacting with the virtual reality shopping environment. In some aspects, a simulation participant interacts within an immersive virtual environment. In other aspects, the three-dimensional image has been presented using virtual reality. In yet other aspects, the three-dimensional image is a current layout of a retail store. In still other aspects the three-dimensional image is an alternative layout of a retail store. In yet other aspects, a simulation participant is recorded during a simulation. In still other aspects, the theme area includes at least one of symbols, imagery and multi-sensory aspects related to the theme. In some aspects, the shopping environment design system further includes multiple virtual representations of a shopping environment. In other aspects, the shopping environment design system further includes real consumer data. In yet other aspects, the shopping environment is linked to live data from multiple shoppers. In still other aspects, the shopping environment is designed jointly by a retailer and a manufacturer. In some aspects, changes to the shopping environment are proposed by a simulation participant. In other aspects, the shopping environment is displayed over a network. In yet other aspects, changes to the shopping environment are made real-time.

In another particular aspect, a method for evaluating at least one proposed modification to a retail environment comprises providing a virtual reality shopping environment comprising a virtual representation of a proposed alternative shopping environment; enabling at least one representative of a retail business to view and interact with the virtual reality shopping environment; providing the representative with feedback from a simulation participant; and receiving input from the representative regarding the proposed alternative shopping environment. In some aspects, the virtual reality shopping environment includes a theme area and an activity-based product grouping. In other aspects, the method further comprises the step of making changes to the proposed alternative shopping environment real-time.

Numerous other features and advantages of the present invention will appear from the following description. In the description, reference is made to exemplary embodiments of the invention. Such embodiments do not represent the full scope of the invention. Reference should therefore be made to the claims herein for interpreting the full scope of the invention. In the interest of brevity and conciseness, any ranges of values set forth in this specification contemplate all values within the range and are to be construed as support for claims reciting any sub-ranges having endpoints which are real number values within the specified range in question.

### FIGURES

The foregoing and other features, aspects and advantages of the present invention will become better understood with regard to the following description, appended claims and accompanying drawings where:

FIG. 1 is a conceptual diagram of a computing environment and virtual reality system.

FIG. 2 is a conceptual diagram further illustrating the virtual reality system shown in FIG. 1.

FIG. 3 is a flow chart illustrating a method for generating a virtual reality simulation.

Repeated use of reference characters in the present specification and drawings is intended to represent the same or analogous features or elements of the present invention.

### Definitions

It should be noted that, when employed in the present disclosure, the terms “comprises,” “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

The term “activity-based themes” refers to an approach for designing a shopping environment where products are physically grouped together and identified in terms of an activity associated with usage of the product. For example a “bath time” theme could include items (i.e., products, packaging, aisle displays, multi-sensory aspects, etc.) relating to bathing.

The term “consumer response measurement tool” refers to a means for measuring a simulation participant's response with respect to a given virtual simulation. As used herein, a simulation participant may or may not be a consumer.

The term “design element modifying tool” refers to a means for allowing changes to be made to the design elements in a virtual simulation. The term “design elements” includes, but is not limited to, store layout, aisle configuration, aisle appearance, shelf layout, product displays and product placement on shelves.

The term “immersive virtual environment” refers to a computer generated simulation of a retail store.

The terms “participant” and “simulation participant” refer to an individual who participates in virtual simulation exercise in accordance with the present invention.

The term “primary level of store organization” refers to the general, or overall, layout of a retailer's store.

The term “secondary level of store organization” refers to an aisle layout within a retailer's store.

The terms “shopping environment” and “store environment” may be used interchangeably.

These terms may be defined with additional language in the remaining portions of the specification.

### DETAILED DESCRIPTION

In response to the needs discussed above, the present invention provides an integrated system of virtual reality tools to generate a virtual shopping simulation that can bring manufacturers and retailers together to jointly explore in a data-rich virtual environment the consumer/market impact of proposed designs for product placement, shelf layout, store aisle layout and general store layout, as well as other aspects of selling products in retail environments. In some aspects, a participant may interact within an immersive virtual environment. A simulation participant may be presented with a representation of a store layout with consumer products on store shelves that correspond with how the store and products appear within a real-world store on which the virtual reality simulation is based. The simulation participant may then navigate through the virtual environment. In this way, the role of physical motion and the significance of physical location, size, and shape of objects (e.g., retail products, aisle layout, store layout, lighting, navigational tools, and the like) may be better simulated.

In some aspects, virtual reality technology can also be incorporated into the system of the present invention. Virtual reality (“VR”) tools can provide enhanced three-dimensional (3-D) capability and can serve as strong analytical and presentation tools. For example, consumers or other participants can interact with virtual reality systems such as VR pods, VR caves, multi-wall display systems, VR headsets, hybrid goggles, head mounted displays (HMDs), and the like. By way of example, VR tools suitable for use in some aspects of the present invention can include the pods and other hardware systems and software systems, such as those marketed by VisionaiR 3D (having a place of business in Tilburg, The Netherlands); display systems, such as those available from Visbox, Inc. (having a place of business in Champaign, Ill., U.S.A.); head-mounted displays, such as those available from Cybermind (having a place of business in Maastricht, The Netherlands) such as the VISETTE PRO; and other devices, such as those available from Tek Gear (having a place of business in Winnipeg, Canada). Suitable VR tools are discussed in further detail below.

The virtual reality system of the present invention includes software or other tools that can generate three-dimensional images of a retail store environment (or of multiple stores belonging to the retailer, or potential acquisition targets of the retailer, and the like) based on Computer Assisted Design (CAD) drawings, photographs, scans and videos (e.g. digital images) or other forms of creating a three-dimensional image. For example, in one aspect of the present invention, one set of three-dimensional images can show the current layout of a retail store including the configuration of store aisles and the location of check-out registers and customer service counters. The configuration of store aisles can include, for example, the number of store aisles, their orientation relative to each other, the width of the aisles, the length of the aisles, the height of the aisles and product placement space within the aisles. An example of virtual reality software that may be used to create and to modify store environments is CONCEPT 7, available from Red Dot Square Solutions, Ltd. (having a place of business located in London, England). Such software may be used to create current and modified sets of images of store environments and may also be used to simulate motion through the virtual store environments.

The systems of the present invention can be implemented as a program product for use with a computer system and can be contained on a variety of computer-readable media. Illustrative computer-readable media include, but are not limited to: (i) non-writable storage media on which information is permanently stored (e.g., read-only memory devices within a computer such as CD-ROM or DVD-ROM disks readable by a CD-ROM or DVD-ROM drive); (ii) writable storage media on which alterable information is stored (e.g., floppy disks within a diskette drive, hard-disk drives, or flash memory devices). Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent aspects of the present invention.

In general, the routines executed to implement aspects of the invention, may be part of an operating system or a specific application, component, program, module, object, or sequence of instructions. The computer program of the present invention typically is comprised of a multitude of instructions that will be translated by the native computer into a machine-readable format and thus executable instructions. Also, programs are comprised of variables and data structures that either reside locally to the program or are found in memory or on storage devices. In addition, various programs described herein may be identified based on the application for which they are implemented in a specific embodiment of the invention. However, it should be appreciated that any particular program nomenclature that follows is used merely for convenience, and thus the invention should not be limited to use solely in any specific application identified and/or implied by such nomenclature.

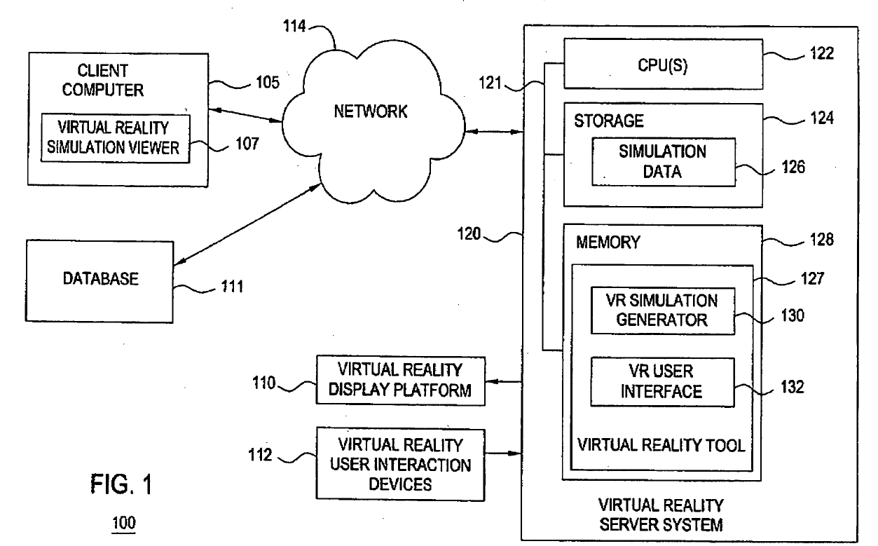

FIG. 1 is a conceptual diagram of a computing environment, including a virtual reality system, according to some aspects of the invention. As shown, computing environment 100 includes a client computer system 105 and a database system 111 in communication with a virtual reality server system 120 over a network 114. The computer systems 105, 111, and 120 illustrated in environment 100 are included to be representative of existing computer systems, e.g., desktop computers, server computers, laptop computers, tablet computers and the like. However, the invention is not limited to any particular computing system, application, device, or network architecture and instead, may be adapted to take advantage of new computing systems and platforms as they become available. Additionally, those skilled in the art will recognize that the illustrations of computer systems 105, 111, and 120 are simplified to highlight aspects of the present invention and that computing systems and networks typically include a variety of components not shown in FIG. 1.

As shown, server system 120 includes one or more CPUs 122, storage 124, and memory 128 connected by a bus 121. CPU 122 is a programmable logic device that executes the instructions, logic and mathematical processing performed in executing user applications (e.g., a virtual reality tool 127). Storage 124 stores application programs and data for use by server system 120. Common storage devices 124 include hard-disk drives, flash memory devices, optical media, and the like. Network 114 represents any kind of data communications network, including both wired and wireless networks. Accordingly, network 114 is representative of both local and wide area networks, including the Internet.

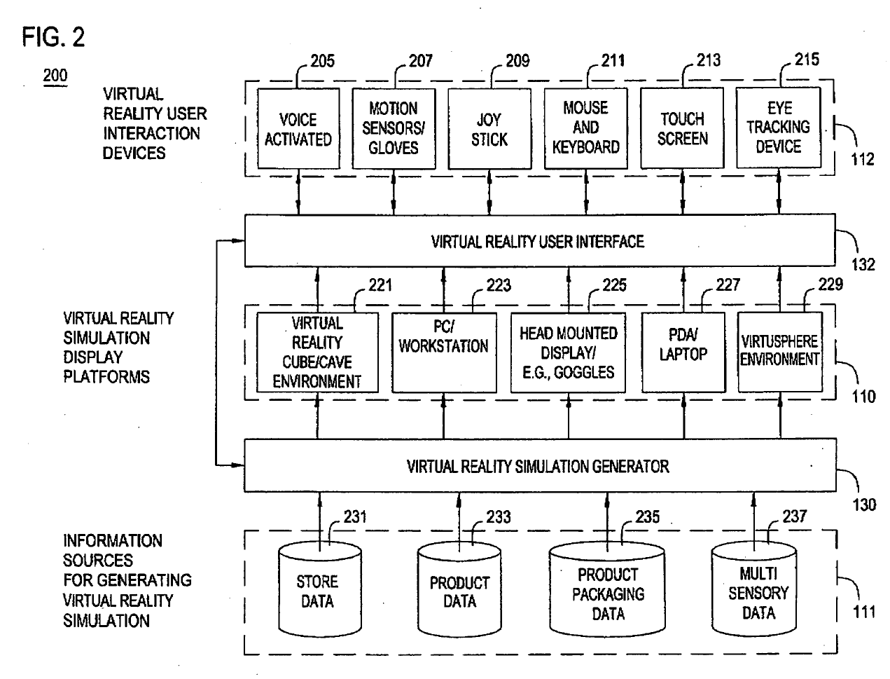

In some aspects, virtual reality tool 127 may be configured to record a simulation participant interacting within a simulated store layout environment. A product designer or market researcher may interact with a server system 120 using client computer system 105 and a viewing application 107. For example, viewing application 107 may be a web-browser configured to display multi-media content such as audio and video streams. To experience the virtual reality simulation of a shopping experience, the simulation participant may interact with a virtual environment presented on a virtual reality display platform 110 using a variety of virtual reality user interaction devices 112 communicating with server system 120. Examples of display platforms 110 and user interaction devices 112 are described below in conjunction with the description of FIG. 2. Additionally, as is well-known, the processing activity of server system 120 may be coordinated by an operating system (not shown). Widely available operating systems include the WINDOWS operating system and distributions of the LINUX operating system, among others.

Database system 111 may be used to store a collection of information used by virtual reality tool 127 to generate a simulation of a given retail store. For example, database system 111 may include descriptions of a store layout used by a retailer, including both current (i.e., in-use) and alternative (i.e, conceptual) layouts of the store. This information may include photographs, videos, CAD drawings or other forms for creating a three-dimensional image. Database system 111 may also store data related to products and product packaging to include in a virtual reality simulation. More generally, database 111 may be used to store any data used to create the virtual shopping experience presented to a simulation participant.

In some aspects, database system 111 and virtual reality server system 120 may be coupled to a virtual reality display platform 110 used to present a simulation participant with a simulated shopping environment. Relevant parties (e.g., retailers and manufacturers) may monitor a simulation participant interacting with the simulated shopping environment. The simulation may include aspects of an initial shopping experience such as the participant entering the store and being presented with a view of the store layout, as well as aisle layouts and product placement on the store shelves. The simulation may also allow the participant to interact with virtual products on the store shelves and to simulate actions such as navigating through the virtual store, placing or removing products from the shelves or aisle displays, removing a product from its packaging, and using the product, all within the virtual shopping environment provided by the virtual reality simulation. Thus, product developers, marketers and researchers can evaluate a broad variety of aspects of the consumer decision making process, as well as aspects of the performance of a particular layout, including but not limited to, product placement, aisle layout, overall store layout, as well as design performance. In some aspects, the relevant parties may simply observe a visualization of the various layouts. In other aspects, the parties may observe a simulation participant's actions or receive summaries about participants' behavior and interaction with a given simulation. Thus, some aspects of the invention may allow these individuals to readily identify opportunities and/or problems with a given store layout, including comparisons between different virtual shopping environments.

Illustratively, memory 128 of server system 120 includes virtual reality tool 127. Virtual reality tool 127 may be a software application, such as described above, that allows a virtual reality shopping simulation to be generated and presented to a user on virtual reality display platform 110. Such a simulation may be configured using simulation data 126 which describes how a store environment should be presented to a participant. Simulation data 126 includes the information needed to present a participant with a particular virtual shopping environment. As shown, virtual reality tool 127 includes a simulation generator 130 and a user interface 132. User interface 132 provides an interface to configure and use virtual reality tool 127. For example, user interface 132 may allow a user to specify simulation data 126 to include in a given simulation, such as a product or store layout to be evaluated, information related to the participant, and the like. Simulation generator 130 may be configured to create the virtual shopping environment from simulation data 126 and present the simulation to a participant on virtual reality display platform 110. In some aspects, the virtual reality simulation may be presented to a retailer and a manufacturer to jointly review and optimize a shopping environment, such as would be found in a retail store. Alternatively, the virtual reality simulation may be presented to a simulation participant who interacts with the simulation while being observed and/or recorded by the retailer and manufacturer for the purpose of optimizing design performance.

Additionally, the virtual reality environment may be augmented to include sounds, smells, and other sensory cues. Sound and smell virtual tools can be configured to change the sounds and smells depending on which section of the virtual retail store is being viewed. In addition, the simulation may include multi-sensory aspects such as the sounds or smells associated with the participant manipulating a particular product. Because the immersive virtual environment may closely mimic an actual shopping environment, the participant's behavior may more accurately reflect what would occur in a real-world store. Thus, together, the simulation provided by the virtual reality display platforms may provide a realistic simulation of the layout, design, and the experience of shopping within a real-world retail store. Thus, the quality of data obtained from the simulation may be greatly enhanced.

FIG. 2 is a conceptual diagram further illustrating components of the virtual reality system first shown in FIG. 1, according to some aspects of the invention. More specifically, FIG. 2 illustrates an exemplary collection of virtual reality display platforms 110, user interaction devices 112 and simulation data stored in database system 111, all of which may be used to generate and present a virtual reality simulation to a simulation participant. As stated above, interaction devices 112 allow a simulation participant to interact with elements of a virtual shopping environment. As shown, devices 112 may include, among other things, a voice activated system 205, motion sensing devices 207 worn by a participant (e.g., a set of motion sensing gloves and/or goggles), a joystick device 209, a mouse and keyboard device 211, a touch screen device 213 and an eye movement tracking device 215. It is understood that, depending on how a virtual reality simulation is presented to a simulation participant, the particular input devices 112 may be tailored to suit the needs in a given situation.

Illustratively, virtual reality display platforms 110 include, but is not limited to, a virtual reality cube or CAVE (Cave Automatic Virtual Environment) 221, a PC workstation 223 and LCD or CRT monitor, a head-mounted display 225 worn by a viewer or simulation participant, a PDA or laptop computer 227 or virtual reality sphere 229. As is known in the art, a CAVE provides an immersive virtual environment where projectors are directed to three, four, five or six of the walls of a cube. The images may be in stereo requiring stereo shutter glasses to be worn. Presenting a simulation participant with a simulation using virtual reality cube 221 may provide the participant with a fully immersive visualization where the screens of the CAVE/CUBE 221 present an interactive virtual shopping environment. In such a case, the participant's entire visual (and possibly other sensory experiences) are provided by the virtual reality cube 221. Similarly, a head mounted display 225, such as a virtual reality helmet or 3-D goggles may provide an immersive virtual environment for presenting a virtual reality simulation of a shopping experience. Additional examples of a head mounted display are described in U.S. Publication No. 2004/0212778 to Velazquez, Herb F., filed May 9, 2003 titled “Vision System and Method for Observing Use of a Product by a Consumer,” incorporated herein by reference in its entirety in a manner that is consistent herewith.

In some aspects, head mounted display 225, typically a set of goggles having display screens, is used within a virtual reality sphere 229. The virtual reality sphere provides a large sphere that allows an individual to enter and move in any direction. The movement of the sphere may be monitored and used to create a virtual shopping experience that responds to the actions of the participant. For example, the user may wear a headset to view a display representation of a retail store. As the participant interacts within the virtual reality sphere, the visual experience provided by the headset corresponds to the participant's movement.

Other examples of virtual reality display platforms 110 include a monitor of PC workstation 223 or a display screen of a PDA or laptop 227. Of course, the invention is not limited to these virtual reality display platforms, and may be adapted for use with other existing platforms as well as new ones that become available. As stated, virtual reality simulation generator 130 may be configured to generate a simulation presented on one or more of display platforms 110 based on specified simulation data 126.

Additionally, the virtual reality environment may be augmented to include sounds, smells and other sensory cues. Sound and smell virtual tools can be configured to change the sounds and smells depending on which section of the virtual retail store is being viewed. In addition, the simulation may include multi-sensory aspects such as the sounds or smells associated with the participant manipulating a particular product. Because the immersive virtual environment may closely mimic an actual shopping environment, the participant's behavior may more accurately reflect what would occur in a real-world store. Thus, together, the simulation provided by the virtual reality display platforms may provide a realistic simulation of the layout, design and the experience of shopping within a real-world retail store. Thus, the quality of data obtained from the simulation may be greatly enhanced.

FIG. 2 also illustrates a variety of exemplary data sources that may be used to specify simulation data 126 for a given virtual reality simulation. As shown in FIG. 2, simulation data may include store data 231, product data 233, product packaging data 235 and multi-sensory data 237. Store data 231 may describe a retail environment for use with a virtual reality simulation. For example, store data 231 includes photographs of a retail store which may be combined with real (or simulated) video footage, CAD drawings, architectural diagrams, and other forms of creating a three-dimensional image.

Product data 233 includes any data related to the product being evaluated and/or simulated as part of a virtual reality simulation. For example, product data 233 may include data related to the product itself, product features, product packaging and the like. Accordingly, product data 233 may specify aspects of a product such as, among other things, product design, size, shape, mass, materials, aesthetics, ergonomic aspects, colors, scents, textures, sounds, user perceptions of usefulness and/or performance, price, branding, perceptions of value, package count, package design, purchase intent, sensory perceptions, and the like; any of which may be used to generate a virtual reality simulation in a given case. Similarly, product packaging data 235 may be used to specify aspects of product packaging to include in a virtual reality simulation. For example, packaging data 235 may specify aspects of packaging performance, such as the opening of a package, the removal of a product from a package, the reusability of a package, the disposal characteristics of a package, and/or the suitability of the package design for a given shelf and store layout.

In addition to data 231, 233, and 235, a virtual reality simulation may be augmented using multi-sensory data 237. In some aspects, in addition to visual features of a virtual reality simulation, a multi-sensory simulation may be generated, including simulations of sights, sounds, tactile responses, or even tastes. For example, a package of cleaning wipes may be virtually represented to appear sitting on a store shelf such that a simulation participant interacting with a virtual shopping environment can remove the virtual package from the shelf and place it in a different location, as if it were a physical package. In addition, the participant may also be exposed to a scent characteristic of the product based on the location of the store in which the participant is located. For example, when the participant enters a baby section of the store, the scent of baby powder may be experienced. Thus, as these examples illustrate, a variety of aspects may be simulated such as the appearance of the product on a store shelf, along with the sounds, smells, and actions resulting from a participant's interaction with the simulated retail environment.

In some aspects, instrumented gloves 207 and other devices in contact with a simulation participant may be used to simulate representations of weight, texture, resilience, warmth, or cooling sensations that occur in response to a participant's interaction with a virtual retail environment. Imagery and sounds may be reproduced in both two-dimensional and three-dimensional versions of the virtual reality simulation. For example, a rapid motion may result in the simulation display platform playing a higher frequency sound than if a slow motion is used. As another example, agitating a virtual product may result in a greater amount of a product scent characteristic to be released into the virtual reality environment.

While a participant interacts with the simulation, the participant's response can be measured with a consumer response measurement tool. Suitable consumer response measurement tools are known to those skilled in the art. For example, the visual experience may be recorded by a simulation recording system. A suitable consumer vision system is described in U.S. Publication No. 2004/0212778 to Velazquez, Herb F., previously incorporated herein by reference in a manner that is consistent herewith. Such a vision system can comprise an article worn by the participant and a camera attached to the article. The vision system can further include a microphone attached to the article. The vision system may further include a display that receives signals from the camera and a speaker that receives signals from the microphone. In some sample forms, the article can be a pin that is secured to the clothing of the individual, or a headband (or cap) that is worn by the individual. In other forms, the article can be a pair of glasses and the camera and microphone can be clipped onto, or integral with, the glasses. The camera may be manually and/or automatically adjustable relative to the article to modify the view as seen by the camera. The system may further include a control that sends signals to the camera which cause an automatic adjustment of the camera relative to the article. The vision system may further include a recorder that records signals (wired or wireless signals) from the camera and the microphone. The vision system may also include an apparatus that is worn by the consumer to hold the recorder.

Additionally, a product designer or market researcher may monitor the actions of the participant using other consumer response measurement tools, such as a simulation viewer 107. For example, a head mounted display may be configured using eye-tracking technology that records what the eyes of the participant are focused on at any given point, and this may be played back using virtual reality simulation viewer 107. Such data can be used to improve the analysis of consumer purchase decisions relative to products on the shelf in the virtual store environment. Suitable eye-tracking tools may include headgear with eye tracking features, where one camera views both the region the consumer is facing and another imaging device observes the motions of the wearer's eye to determine the direction of the eye. The data can then be assimilated to show which part of the field of view was being looked at by the wearer of the headgear. This information can be utilized with digital information about the actual shelf, such as a virtual representation of the products on the shelf, allowing viewers to observe the shelf and to see the overlaid eye-tracking results. The combination of real eye-tracking data with a virtual representation of the shelf can be used to provide many insights into consumer behavior. For example, data from multiple eye-tracking tests can indicate trends, such as a propensity for consumers to first notice a yellow package, and then be drawn to more intense study of a color image on the package. Correlations between eye-tracking data and purchase behavior may then be used to identify trends that can be exploited to optimize a store's layout, and ultimately to increase sales. With sufficiently powerful computational tools, quantitative analyses of eye-tracking data may be completed quickly and key findings may be graphically displayed to let users of the system promptly interpret the impact of changes.

Another example of a consumer response measurement tool includes biofeedback monitoring to monitor a participant's physiological responses, such as heat rate, breathing, and other factors that may provide subtle information about emotional responses. During the simulated shopping experience, equipment in a head mounted display and on the body of the participant may be configured to monitor, detect, and record physical stress or other physical responses associated with actions of the participant, such as those that occur while reaching for an object, stooping to retrieve an object from a lower shelf, pushing a loaded cart, or navigating around shelves, aisles, or other obstacles, for example.

In some aspects of the present invention, the participant need not know that such monitoring is occurring. For example, a camera may record information about the facial response of a participant, which can then be analyzed for subtle cues (eye motion, action of various muscles in the face, etc.) to determine the appearance of the product. Principles of computerized facial analysis are discussed by A. Sarrafzadeh et al., “Facial Expression Analysis for Estimating Learner's Emotional State in Intelligent Tutoring Systems,” Third IEEE International Conference on Advanced Learning Technologies (ICALT'03), 2003, p. 336 (see http://doi.ieeecomputersociety.org/10.1109/ICALT.2003.1215111).

In addition to those described above, other consumer response measurement tools for evaluating consumer preferences include computerized systems with multiple participants joined by a network and multimedia marketing research systems for optimizing product properties. Exemplary systems and methodologies include those of US 2002/0152110A1, published Oct. 17, 2002 by B. Stewart et al. and US 2003/0126010A1, published Jul. 3, 2003 by P. A. Levitsky; each of which is incorporated herein by reference in a manner that is consistent herewith. With such systems, multiple participants may be joined in a network, each capable of interacting with a proposed product in simulated three-dimensional (3-D) space. For example, participants wearing head mounted display systems and instrumented gloves may be able to see the virtual object in three dimensions and move its virtual representation using hand motions. Alternative product forms may be displayed to allow participants to compare the 3-D representations of the items and make selections between various alternatives.

In some aspects of the invention, the shopping environment design system includes a set of three-dimensional images showing the current, or a proposed (i.e., alternative) layout of the retail store. These images can include both primary and secondary levels of store organization. That is, the images can include a store layout (primary level of store organization) and an aisle layout (secondary level of store organization). The configuration or layout of aisles includes arrangement of the shelves or other display devices within a particular aisle, current arrangement of products on those shelves, end-of-aisle displays or other display devices and images of each individual product found within a particular aisle of the store. More general aspects of the retail store can also be represented by the three-dimensional images including the lighting within the store (natural and artificial), the ceiling height, the color of walls and floor, and the like.

In some aspects, a second set of three-dimensional images can be created in which modifications are made to the layout of the retail store. These modifications can be made using a design element modifying tool, and can occur at the primary and/or the secondary level of store organization. For example, modifications to the primary level of store organization may include an arrangement of aisles, a different number of aisles within the store and different locations for check-out registers, customer service and entrances/exits. Modifications to the secondary level of store organization may include new product groupings, different individual products, different shelf heights and spacings, new display devices and product assortments. Suitable design element modifying tools include, but is not limited to, a keyboard, a mouse, modeling software such as CONCEPT 7 (available from Red Dot Square Solutions, Ltd.), creative development software such as ADOBE PHOTOSHOP 7 (available from Adobe Systems Incorporated), CAD/CAM drawing programs such as AUTODESK 3DS MAX 9 (available from Autodesk, San Rafael, Calif., U.S.A.), three-dimensional rendering software such as SKETCHUP PRO5 (available from Google, Mountain View, Calif., U.S.A.), SPINFIRE (available from Actify, Inc., San Francisco, Calif., U.S.A.), MAYA (available from Autodesk, San Rafael, Calif., U.S.A.), BLENDER (available from Blender Foundation, Amsterdam, The Netherlands), and the like.

As referenced above, general aspects of the virtual retail store may also be modified including controlled sound, lighting, ceiling height, windows and controlled smells. Both the first set of three-dimensional images and the second set (or additional sets) of three-dimensional images may be viewed from various angles and distances and may be used for simulated walk-throughs or fly-throughs of the three-dimensional space. By creating one or more virtual representations of the shopping environment, both the manufacturer and the retailer may learn how changes to the environment impact the traffic pattern of shoppers within the store, shopper exposure to products, visibility of products to shoppers and product selection by shoppers. Creating modified shopping environments using virtual reality tools is substantially more cost efficient than creating new physical environments. The virtual shopping environments may also be used to conduct consumer and market research, and to visualize and communicate the concept.

In one aspect of the invention, real consumer data may be integrated with the virtual display of the retail store environment. For example, the consumer data may provide point-of-sale or loyalty card information that can be used to identify and display “hot spots” in the store, for example, a physical location within the store where a significant volume of product is selected by shoppers. In another aspect, the virtual shopping environment can be linked to live data from multiple shoppers to obtain real-time, or nearly real-time, feedback from consumers about proposed changes. For example, a group of consumers may be available during a meeting of the manufacturer and retailer to respond to different modifications made to the shopping environment.

Examples of modifications to the store environment that may be tested with shoppers include design elements such as package colors, shape and other aspects of the appearance of product packages; the layout, spacing, product arrangement and available product assortment of shelves; and the dimensions, location and appearance of aisles within the store environment, and the like. The group of test consumers may be tied into the system displaying the virtual store environment so that they may explore areas of interest, or the store in general, and so that they may respond to the changes. For example, multiple test consumers may be in virtual reality pods and asked to shop in the baby section of a virtual store environment for diapers. One group of test consumers may be given access to the set of three-dimensional images representing the current form of the shopping environment, while a second group of test consumers may be given access to the set of three-dimensional images representing a modified (i.e., alternative) form of the shopping environment. The test consumers in both groups may then be asked a series of questions, or asked to provide input, in order to make a comparison between the two store environments and to draw conclusions about the impact of the modified environments on shopper/consumer behavior. In another aspect, a given participant may be provided with a virtual experience of both store environments.

In a relatively brief period of time, a large quantity of data may be collected from the test consumers' responses/reactions to the virtual environments in order to identify which of two or more proposed environments is more successful in achieving a particular objective. As discussed above, consumer response measurement tools, such as eye tracking tools or biofeedback monitoring, may be used in addition to other tools for monitoring overt purchasing behaviors and interactions with products to obtain useful information about the potential success of proposed changes.

With such a system for designing shopping environments, an executive, business partner, consultant, simulation participant, etc. may propose, for example, that a manufacturer's products be put on the upper shelf instead of the lower shelf. The changed location of the products can be quickly entered into the computerized, virtual system to alter how the store environment appears. Representatives from both the retailer and the manufacturer may jointly observe in a realistic, three-dimensional environment how the proposed changes look. Thus, feedback from participants may be quickly obtained and results can be generated pointing to the possible success or weakness of the proposed change in terms of one or more metrics.

In one aspect of the invention, representatives of a retailer are shown a virtual reality representation of their store or business and one or more additional representations corresponding to one or more proposed alternatives for their store or business (i.e., differing product design, modified packaging, shelf space, shelf layout, aisle markings, lighting, and the like.). The representatives interact with the virtual reality representations to assist in their evaluation of the one or more proposed alternatives. The impact of one or more proposed alternatives on user (e.g., shopper) response or on the response of other users can be examined by providing data from participants who engage in simulated shopping trials in one or more of the available virtual reality representations.

In one aspect, representatives of the retailer or other parties can make proposed changes during a review session with the virtual reality system, have the proposed changes input into the associated computing system governing the virtual reality system, and shortly thereafter observe the proposed changes in the virtual environment to interactively explore their impact. In a related aspect, the proposed changes are also made available for human users to interact with, such as in a simulated shopping experiment, to gather feedback from the users based on their activities and response to the modified virtual environment. In this manner, a meeting between vendors and customers can be enhanced with the virtual display system to allow both parties to discuss proposed modifications to a retail environment or other business in order to interactively explore alternatives and optionally gather feedback from human users regarding the impact of the alternatives on factors such as buying decisions, shopping behaviors, marketing effectiveness, eye appeal, time spent exploring a targeted portion of an aisle, and the like.

In addition to virtual reality pods, simple computer displays of modified layouts or products can be displayed over the Internet or another network to obtain prompt feedback from test consumers. The system of the invention not only allows a manufacturer and a retailer to work together in a common, virtual, three-dimensional setting to allow modified designs to be explored, but it also adds the significant benefit of nearly real-time feedback from linked test consumers who can, among other things, comment on the proposed changes, and provide data from simulated shopping experiences to help decision-makers understand strengths and weaknesses of proposed changes that can be made on-the-fly (i.e., real-time).

Another aspect of the invention is the ability of the system to display the retailer's store environment having objects such as display devices and products where the images have been adjusted based on the requirements of the retailer, the manufacture, or both. The adjustments may include modifications to the size of the product packaging, the product graphics, the product assortments available, the allocation of shelf space, competitive product offerings, schemes and themes, and the like.

In addition to the modifications to store environments that may be developed and researched using the system of the invention, the system of the invention may also be used to create and conduct research on activity-based themes within store environments, as defined above. Virtual reality systems may be used to create images of a store environment including elements that currently exist and elements that would need to be developed. The virtual reality system may be used to create demonstrations showing current images of the store environment, modifications to existing elements to achieve the activity-based theme area, and introduction of new elements to achieve the activity-based theme area.

The demonstration may show the transformation from current layout (primary and secondary levels of organization) to a new layout that forms an activity-based theme area. The effectiveness of the activity-based theme area may be tested with retailers and shoppers/customers within the virtual environment. An example of an activity-based theme area may be developed for the section of a retail store that offers products for babies, for instance. If the theme area is dedicated to products for babies and young children, appropriate activity groupings may include nursing, feeding, bathing, diapering, toilet training and playing. By way of example, the products within the “nursing” activity area may include nursing pads, bottles, infant formula, and the like; products within the “feeding” activity area may include baby food, bibs, teething rings, cleaning wipes, and the like; products within the “bathing” activity area may include shampoo, body wash, lotion, cleaning mitts, towels, and the like; products within the “diapering” activity area may include disposable diapers, cloth diapers, changing pads, cleaning wipes, powders, anti-rash ointments, and the like; products within the “toilet training” activity area may include training pants, toilet training kits, toilet paper, cleaning wipes, motivational aids, and the like; and products within the “playing” activity area may include toys, books, music, swim pants, sunscreen, hats, and the like.

A theme area of a store may be developed to include symbols and imagery related to the theme, as well as the associated activities. For example, if the theme area is babies and young children, appropriate imagery may include photographs of babies, cartoon characters, animals and primary communication concepts such as letters and numbers. The imagery may be incorporated into the store environment using physical objects such as shelves, displays and artwork or by using non-physical elements such as sounds and smells, as well as other multi-sensory aspects. The system of the invention may be used to create virtual store environments that include theme areas and activity-based product groupings.

By creating the theme areas and activity-based product groupings in a virtual environment, research may be conducted on the impact of the environment on product sales before money is invested to create real versions of the theme areas and activity-based product groupings. Adjustments and modifications may be made and evaluated before designs for the theme areas and activity-based product groupings are finalized.

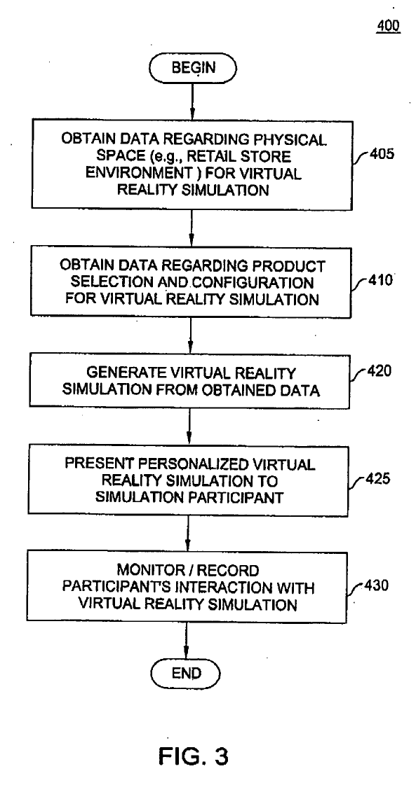

To gain a better understanding of the invention, reference is made to FIG. 3. FIG. 3 is a flow chart illustrating a method for generating a virtual reality simulation which, in some aspects, can include an activity-based theme. As shown, the method 400 begins at step 405, where primary level data describing a physical space for a virtual reality simulation is obtained. For example, as described above, a retailer may provide photographs or CAD drawings of actual (or proposed) store layouts. At step 410, secondary level data, such as aisle layout and/or product information for use in the virtual reality simulation is obtained. Further, such information may include multi-sensory data related to the store environment to use in the virtual reality simulation. At step 415, utilizing a virtual reality system, the input data obtained at steps 405 and 410 are used to generate a virtual reality simulation, which may include an activity-based theme in some aspects. At step 420, the virtual reality simulation generated at step 415 may be presented to the participant. Once “active,” the participant may interact with the activity-based theme layout in the virtual reality shopping environment in any of the ways described above. At step 425, while the participant interacts with the simulation, a retailer and/or manufacturer (among others) may observe using a consumer response measurement tool. At any time before, during or after the simulation, the shopping environment may be modified using a design element modifying tool (not shown). In some aspects, the participant's interactions may be monitored by the virtual reality display platform and stored for subsequent review.

It will be appreciated that details of the foregoing example, given for purposes of illustration, are not to be construed as limiting the scope of this invention. Although only a few exemplary embodiments of this invention have been described in detail above, those skilled in the art will readily appreciate that many modifications are possible in the examples without materially departing from the novel teachings and advantages of this invention. For example, features described in relation to one example may be incorporated into any other example of the invention.

Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention. As various changes could be made in the above constructions without departing from the scope of the invention, it is intended that all matter contained in the above description shall be interpreted as illustrative and not in a limiting sense.

1.-14. (canceled)

15. A shopping environment design system comprising:
a computing environment;
a virtual reality system operatively associated with the computing environment and configured to produce a virtual reality shopping environment according to at least one three-dimensional image of a shopping environment, the three-dimensional image including design elements selected from one or more of store layout, aisle configuration, aisle appearance, shelf layout, product displays and product placement on shelves; wherein the shopping environment includes a theme area and an activity-based product grouping;
a design element modifying tool configured to modify the design elements, whereby the virtual reality shopping environment is changed; and
a consumer response measurement tool configured to measure responses of a user interacting with the virtual reality shopping environment.

16. The shopping environment design system of claim 15 wherein a simulation participant interacts within an immersive virtual environment.

17. The shopping environment design system of claim 15 wherein the three-dimensional image has been presented using virtual reality.

18. The shopping environment design system of claim 15 wherein the three-dimensional image is a current layout of a retail store.

19. The shopping environment design system of claim 16 wherein the three-dimensional image is an alternative layout of a retail store.

20. The shopping environment design system of claim 15 wherein a simulation participant is recorded during a simulation.

21. The shopping environment design system of claim 15 wherein the theme area includes at least one of symbols, imagery and multi-sensory aspects related to the theme.

22. The shopping environment design system of claim 15 further including multiple virtual representations of a shopping environment.

23. The shopping environment design system of claim 15 further including real consumer data.

24. The shopping environment design system of claim 15 wherein the shopping environment is linked to live data from multiple shoppers.

25. The shopping environment design system of claim 15 wherein the shopping environment is designed jointly by a retailer and a manufacturer.

26. The shopping environment design system of claim 15 wherein changes to the shopping environment are proposed by a simulation participant.

27. The shopping environment design system of claim 15 wherein the shopping environment is displayed over a network.

28. The shopping environment design system of claim 15 wherein changes to the shopping environment are made real-time.

29. A method for evaluating at least one proposed modification to a retail environment, comprising:
providing a virtual reality shopping environment comprising a virtual representation of a proposed alternative shopping environment;
enabling at least one representative of a retail business to view and interact with the virtual reality shopping environment;
providing the representative with feedback from a simulation participant; and
receiving input from the representative regarding the proposed alternative shopping environment,
wherein the virtual reality shopping environment includes a theme area and an activity-based product grouping.

30. (canceled)

31. The method of claim 29 further comprising the step of making changes to the proposed alternative shopping environment real-time.

32. The method of claim 29 wherein the simulation participant interacts within an immersive virtual environment.

33. The method of claim 29 wherein the simulation participant is recorded during a simulation.

34. The method of claim 29 wherein the virtual reality shopping environment comprises multi-sensory aspects.

35. The method of claim 29 wherein the virtual reality shopping environment is displayed over a network.
